(19) United States
(12) Patent Application Publication
(10) Pub. No.: US 2005/0086097 A1
(43) Pub. Date: Apr. 21, 2005

(54) Method and apparatus for collecting processed material

(76) Inventors: Robert C. Taggart, Oldwick, NJ (US); Mary A. Taggart, Oldwick, NJ (US); Patrick M. Logan, Stewartsville, NJ (US)

Correspondence Address: COVINGTON & BURLING;ATTN: PATENT DOCKETING, 1201 PENNSYLVANIA AVENUE, N.W., WASHINGTON, DC, 20004-2401, US

(21) Appl. No.: 10/915,697

(22) Filed: Aug. 11, 2004

Related U.S. Application Data
(60) Provisional application No. 60/494,084, filed on Aug. 12, 2003.

(51) Int. Cl. G06F 17/60

(52) U.S. Cl. 705/10

(57) ABSTRACT

A system and method is provided for conveniently collecting woods chips or similar items. In one embodiment, a bag made from a lightweight mesh material and webbed portion is used as the liner of a wood chip truck, in which the bag collects the wood chips and can be easily removed from the truck when filled. A method of conducting a recycling business is also provided.

### CROSS-REFERENCE TO RELATED APPLICATIONS

This application claims priority under 35 U.S.C. § 119(e) to U.S. Provisional Application No. 60/494,084, filed Aug. 12, 2003, the entirety of which is incorporated herein by reference.

### BACKGROUND OF THE INVENTION

1. Field of Art

The present invention relates generally to the collection and disposal of shredded or processed material. More specifically, the present invention relates to an improved apparatus and method for collecting and disposing of wood chips and the like.

2. Related Art

A primary activity of tree services is the removal of trees from residential and commercial properties. As part of this process, tree services generate large amounts of refuse, such as wood chips, as they process removed trees by putting them through wood-chippers. The disposal of such refuse is extremely costly and logistically arduous. In general, wood chips and the like are deposited into conventional wood chips trucks. These trucks generally have an enclosed volume into which the wood chips are blown by wood chippers. Once the truck is full, the tree service must cease work on the job site and travel to and from a recycle center where the load of wood chips is to be deposited. Moreover, once the wood chip truck reaches the recycling center, such trucks typically cannot dump the chips directly into refuse containers. Rather, they must first dump the chips onto the ground, and then either manually or by front-end loaders, load the chips into dumpsters.

Alternatively, recycling centers may provide containers to be used by tree services on job sites. Thus, when the tree service fills the container, the recycling center sends a “roll off” truck to the site to pick up the container and return it to the recycling center. This generally requires having at least two containers per location—the roll off truck must bring an empty container to the site at the time it picks up the full container so that the work on the site will not be interrupted. The need to have two containers per location adds cost to the process—a standard size container (30 cubic yards) may cost about $3,500. Moreover, with this arrangement, the recycling center must make a round trip for each customer each time the container is filled.

A method and machine for packing wood chips is disclosed in U.S. Pat. No. 4,044,525 to Forsgren (“the '525 patent”). The apparatus disclosed in the '525 patent appears to encompass a wood chipper and tube-like package into which the wood chips are blown. The apparatus disclosed in the '525 patent, however, cannot be used with conventional wood chip trucks to eliminate the problems discussed above. Thus, there is still a need in the art for a bag or like device that may serve as a liner for a conventional wood chip truck that can be removed from the truck for later transportation to a processing center.

Thus, a need exists for a method and apparatus to alleviate the problems associated with the removal of wood chips or similar processed refuse from job sites, such as tree removal sites.

### SUMMARY OF INVENTION

The present invention provides an innovative bag for collecting wood chips and the like. In one embodiment, the present invention provides a method for collecting a processed material comprising providing a vehicle having an enclosed volume with an open end, disposing a bag in the enclosed volume such that the bag lines substantially the entire enclosed volume and has an opening adjacent to the open end of the enclosed volume, depositing a processed material into the bag, and removing the bag with the deposited processed material from the enclosed volume.

In another embodiment, the present invention provides an apparatus for collecting a processed material comprising a bag comprising panels connected by webbed portions wherein the bag lines substantially the entire volume of a vehicle such as a wood chip truck and is configured to collect the processed material. In an alternative embodiment, the bag is held in place by a frame.

The present invention also provides a method for conducting a recycling business comprising obtaining raw materials from an end user, processing the raw material into a recyclable material, delivering the recyclable material to a recycler to process into a processed material, selling the processed material to the end user and receiving payment responsive to a volume of raw material obtained from the end user. An alternative method comprises obtaining a recyclable material from a recyclable material source, wherein the recyclable material source obtained raw material from an end user and processed the raw material into the recyclable material, delivering the recyclable material to a recycler to process into a processed material, and delivering the processed material to the recyclable material source, wherein the recyclable material source sells the processed material to the end user, and wherein the recyclable material source receives payment responsive to a volume of raw material obtained from the end user.

### BRIEF DESCRIPTION OF THE FIGURES

The foregoing summary, as well as the following detailed description, will be best understood in conjunction with the attached drawings, which are incorporated in and constitute part of the specification. The drawings illustrate preferred embodiments of the invention, and, together with the description, serve to explain the principles of the present invention.

FIG. 1A is profile view of a bag according to an embodiment of the present invention.

FIG. 1B is a depiction of a bag closure mechanism according to an embodiment of the present invention.

FIG. 1C is a depiction of a bag according to an embodiment of the present invention.

FIG. 2 is a depiction of a bag installed in a truck according to an embodiment of the present invention.

FIGS. 3A-3C are diagrams of cams according to embodiments of the present invention.

FIG. 4 is an example of a bag according to an embodiment of the present invention being lifted by, for example, a boom lift truck.

FIGS. 5A-5F are depictions of a bag according to an embodiment of the present invention from different viewpoints.

FIGS. 6A-6B depict a diagram of a process for assembling a bag according to an embodiment of the present invention.

FIGS. 7A-7E are depictions of a bag being assembled according to the process depicted in FIG. 6.

FIGS. 8A-8B are diagrams of business methods according to embodiments of the present invention.

FIG. 9 depicts an embodiment of the present invention in which a bag is held in position by a frame.

FIG. 10 depicts an embodiment of the present invention in which a bag is held in place without use of a frame.

### DETAILED DESCRIPTION OF THE PREFERRED EMBODIMENTS

Reference will now be made in detail to preferred embodiments of the invention, examples of which are illustrated in some of the drawings. The figures and examples below are not meant to limit the scope of the present invention or its embodiments or equivalents.

In one embodiment of the present invention, a bag is provided for the collection of processed or shredded materials such as wood chips. The bag is preferably designed so that it may be readily and easily placed in a standard pick-up truck, chipper truck, dump truck or similar vehicle and does not require the user to retro-fit the truck with a chipper-box. Once fill, the bag may then be removed from the truck and dumped in a convenient location. The bag may then be picked up by a grapple boom truck, and loaded onto another truck for removal from the site.

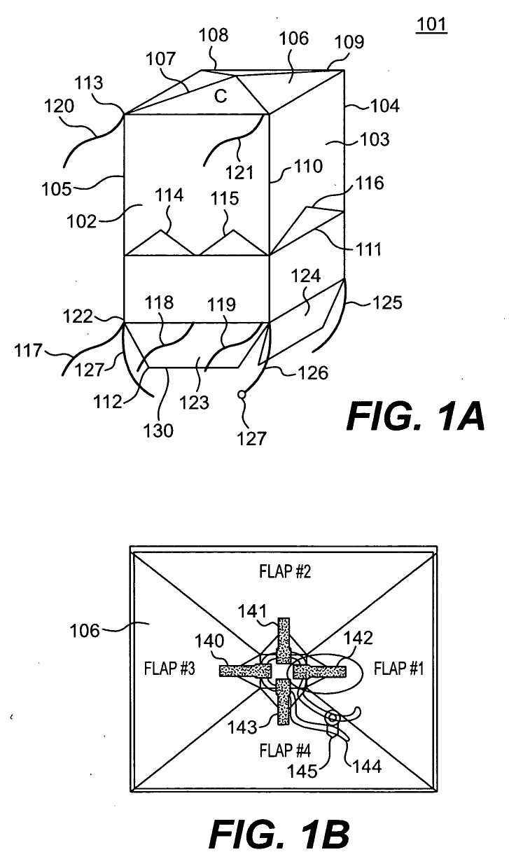

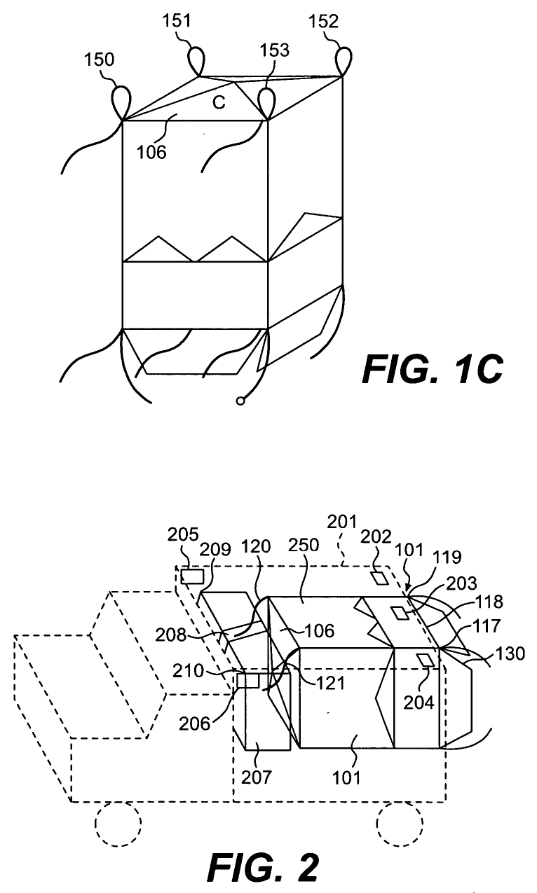

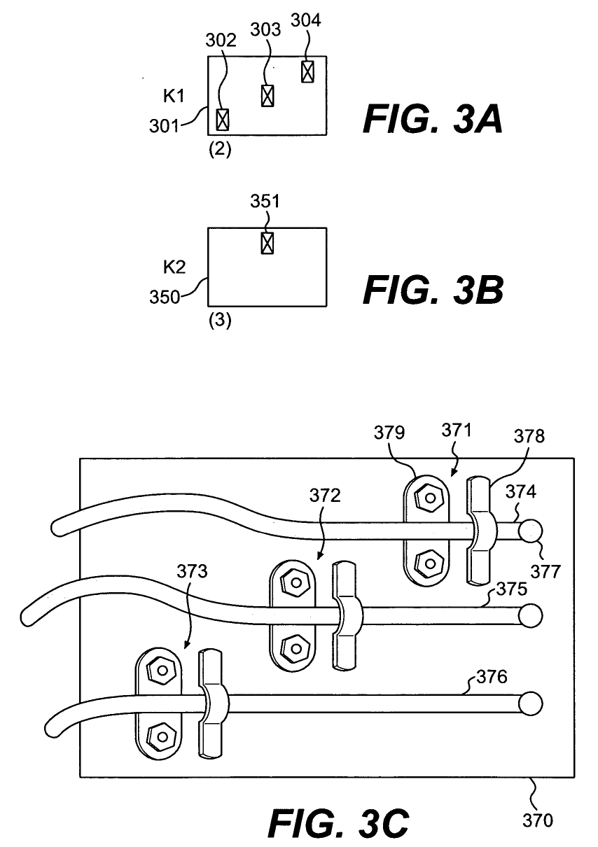

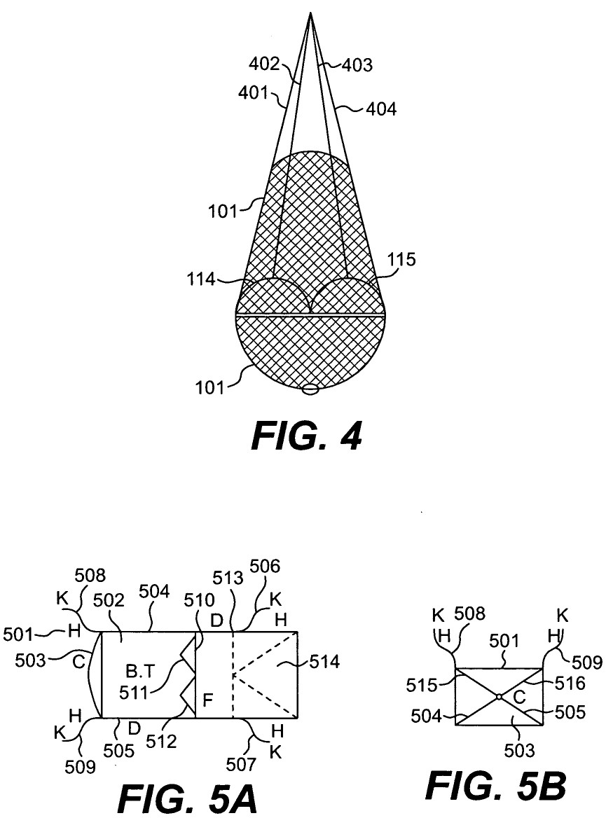

A profile view of a bag according to an embodiment of the present invention is shown in FIG. 1A. Bag 101, as shown in FIG. 1A, comprises side panels 102, 103, 104 (not shown) and 105 (not shown), and back panel 106. The orientation of bag 101 in FIG. 1A, is such that “back” panel 106 is located at the “top” portion of the FIG. 1A. However, back panel 106 is referred to as a “back” panel because is the usual course of operation, bag 101 would be oriented so that the this portion of bag 101 would be inserted into the appropriate location first, and the “front” portion 130 of bag 101 would be open to receive wood chips and the like. Thus, the “back” portion of a bag according to an embodiment of the present invention generally refers to the end section that is closed during the bag filling operation and the “front” portion of the bag is the end section that is open during the bag filling operation. Such an orientation is shown for example in FIG. 2.

Although side panels 104 and 105 are not shown in this particular view of bag 101, they are similar to side panels 102 and 103, respectively. The side panels and back panel are preferably made from a light-weight mesh material, such as a lightweight polypropylene woven material, that is air and water permeable. An example material may be an 80% shade fabric with a 3.8 oz per square foot tensile strength. The precise material for these panels, however, is not critical and they may be made from any number of materials that are lightweight and strong, and preferably air and water permeable and resistant to mildew. The side panels in FIG. 1A are connected by webbed sections 107, 108, 109, and 110. These webbed sections are preferably made from a 2 inch polypropylene webbing material with an 800 lb. tensile strength that serves not only to connect the side panels but also to provide reinforcement to allow the bag to carry a significant amount of weight, such as 3,500 lbs. Back panel 106 is preferably coupled to the side panels by being sewn to the side panels. In addition, webbed section 107-110 are folded over back panel 106, such that they form diagonals across it, and are sewn to back panel 106.

In a preferred embodiment, the webbed sections (e.g., 107, 108, 109, and 110) may be reinforced, such as by using wider polypropylene webbing material and/or folding the webbing material over itself to essentially double its thickness. Such reinforcement allows for the bag to hold the appropriate amount of weight and also to maintain the bag when the bag is lifted and carried.

An additional webbed section 111 is coupled, preferably by sewing, to the side panels approximately halfway between the top edge 112 and bottom edge 113 of the side panels. The precise position of webbed section 111, however, is not critical to the invention. Webbed section 111 preferably is wrapped completely around bag 101. Coupled to webbed section 111 are loops 114, 115, and 116. Additional loops are also coupled to webbed section 111 on the faces of side panels 104 and 105 (not shown) in a fashion similar to that shown in FIG. 1A. These loops are preferably made from a 2 inch webbing material similar to that which comprises, for example, webbed section 107.

Ropes 117, 118, 119, 120, and 121 are coupled to side panel 102, preferably by sewing. As shown in FIG. 1A, ropes 117-119 are coupled near the top edge 112 of side panel 102 and ropes 120 and 121 are coupled near the bottom edge 113 of side panel 102. These ropes are preferably made from a nylon material and can be used to tie bag 101 to a truck bed, as described below.

As can be seen in FIG. 1A, webbed sections 107-110 are not coupled to the side panels for their entire length, but diverge from the panels, for example, at point 122. This allows the side panels to form essentially four flaps near their top end 112. Two of these flaps, 123 and 124, can be seen in FIG. 1A. Two similar additional flaps are associated with side panels 104 and 105 but are not shown in FIG. 1A. Additionally, this arrangement results in uncoupled end portions 125, 126, and 127 of the webbed portions 109, 110, and 107 respectively. (An additional similar uncoupled end portion of webbed portion 108 is present but not visible in FIG. 1A.)

Connected to one of these uncoupled end portions, such as end portion 126, is grapple hook 127. Grapple hook 127 preferably has a break strength of at least 7,500 lbs. Another end portion can then be looped through grapple hook 127 in order to assist in closing bag 101 when it is desired to remove it from its position. Preferably, the end portion that is located diagonally across from the end portion with the grapple hook (in this case, the end portion of webbed portion 108) is looped through the grapple hook. The remaining two end portions (here, 125 and 127) are provided with opposing Velcro or similar removably adhesive material so that they can also assist in closing bag 101. Thus, for example, flaps 123 and 124, as well as similar flap portions (not shown) associated with side panels 104 and 105 may be folded over to close bag 101. The end portions may then be attached by the grapple hook and Velcro, which serves to hold the flaps in place and further assist in closing bag 101 for removal.

As an alternative to the grapple hook/Velcro arrangement just described, the closure of the bag may be effected by a “duffle bag” type closure. As shown in FIG. 1B, attached to back panel 106 are 4 loops (140, 141, 142, and 143). These loops are preferably made from a polypropylene material similar to webbed sections 107, 108, 109, and 110 and sewn into position in a manner similar to the webbed sections described with respect to FIG. 1A. As is known in the art, a draw string (144) is threaded through the loops and a locking mechanism (145) is used to close the bag.

FIG. 2 shows a depiction of a bag, such as bag 101 from FIG. 1A installed in a truck 201, such as a conventional wood chip truck. A conventional wood chip truck, such as truck 201, generally has an enclosed space with an open end into which wood chips or other processed refuse are placed. In a preferred embodiment of the present invention, bag 101 is installed in such a truck such that it encompasses substantially this entire enclosed space so that wood chips or the like can be deposited directly into the bag, rather than the truck. Thus, bag 101 acts essentially as a liner of the truck enclosed volume and takes on its shape. This can be seen in FIG. 2, wherein the bag 101 encompassing substantially all of the enclosed volume 250 of truck 201. A possible exception to encompassing all of the enclosed volume 250 would be leaving room toward the back end of the enclosed volume 250 for additional rolled-up replacement bags, such as bag 207 (described in more detail below). Thus, as used herein, a bag substantially lines the entire volume of a truck or other vehicle if it lines substantially all of that volume with the exception of the portion of that volume that is taken up by one or more rolled-up replacement bags such as bag 207.

In another embodiment, a bag of the present invention may be designed to be a liner for the truck bed of a conventional pickup truck. Thus, the present invention need not be used with vehicles with an “enclosed” volume.

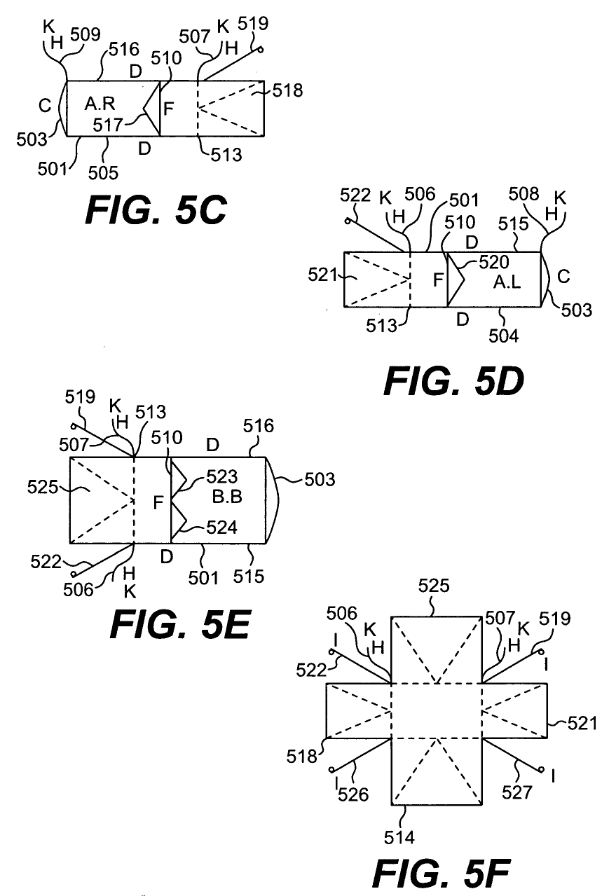

As shown in FIG. 2, truck 201 is fitted with a series of cams 202, 203, 204, 205, and 206. These cams are similar to those used in conventional sailing applications and allow a rope to be threaded through them to tie down or hold open bag 101. Representative cams are shown in FIGS. 3A-B. For example, as shown in FIG. 3A, cam 301 is provided with 3 fastener portions 302, 303, and 304. Each fastener portion is essentially a metal loop through which a single rope, such as rope 117, may be threaded in order to tie down a bag to a truck. Alternatively, a cam such as cam 350, shown in FIG. 3B, with one fastener portion 351 may be provided.

A more detailed view of a cam may be seen in FIG. 3C. As shown in FIG. 3C, cam 370 is provided with 3 fastener portions 371, 372, and 373 through which ropes 374, 375, and 376 are fastened. In this embodiment, each fastener portion consists of a hole, e.g. 377, through which the rope may be threaded, a metal loop 378 which holds the rope in place, and a locking portion 379 which further serves to hold the rope and prevent it from pulling away from the cam 370.

In the embodiment shown in FIG. 2, cams 202, 203, and 204 are preferably similar to that shown in FIG. 3B, with one fastener portion each. Through each of the cams, one of the ropes 117-119 is fastened (for example, rope 117 through cam 204) in order to assist in holding bag 101 into an open position. Cams 205 and 206 are preferably similar to that shown in FIG. 3A. Ropes 121 and 120 are preferably fastened to cams 205 and 206, respectively, in order to hold bag 101 into truck 201. Moreover, because cams 205 and 206 have three fastener portions each, two additional bags (similar to bag 101) may be fastened to these cams. The two additional bags are preferably rolled up and located behind bag 101.

An example rolled up bag 207 is shown in FIG. 2. It is coupled to truck 201 by ropes 209 and 210 which engage cams 205 and 206, respectively. These additional bags may be held in a rolled-up position by a strap 208 wrapped around the bag, similar to the way in which an umbrella is maintained in closed position when not in use. Thus, when bag 101 is filled, it can be removed, and a second bag can be unrolled and fastened to cams 202-204 (in a similar fashion as bag 101). In this way, the time and effort involved in removing a filled bag and positioning a new empty bag in place for receipt of additional material is reduced.

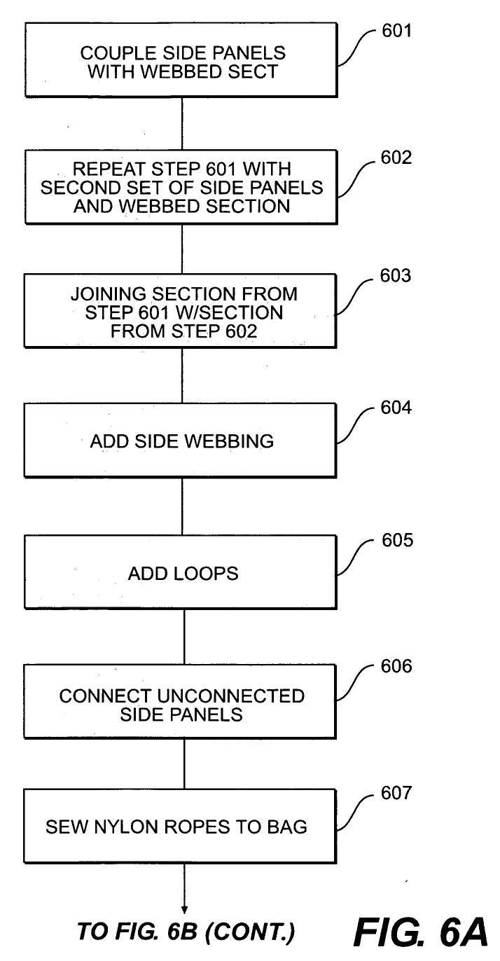

As indicated above with respect to FIG. 1A, after bag 101 is filled, it may be closed by folding over the flaps of the side panels (e.g., flaps 123 and 124) and holding the flaps in place with the end portions (e.g. 125, 126 and 127). The bag may then be removed from a truck, such as truck 201 by, for example, dumping the bag onto the ground. Once the bag has been dumped onto the ground, it may be conveniently removed from the site by using, for example, a grapple boom truck. For example, as shown in FIG. 4, lifting cables 401-404 may be coupled to bag 101 via loops, such as loops 114 and 115. These lifting cables may then be used, for example, by a grapple boom truck to lift the bag for loading onto another truck. This truck may then, for example, take bag 101 to a recycling center for further processing of the materials contained therein.

In a preferred embodiment, the webbed section 111 and loops 114, 115, and 116 may be omitted entirely. Instead, as shown in FIG. 1C, loops 150, 151, 152, and 153 may be added at or near the comers of back panel 106. These loops are preferably made from a polypropylene material similar to webbed sections 107, 108, 109, and 110 and sewn into position in a manner similar to the webbed sections described with respect to FIG. 1A. As a preferred alternative to the use of webbed section 111 and loops 114, 115, and 116 to lift the bag (as shown in FIG. 4), lifting cables (such as 401, 402, 403, and 404) as shown in FIG. 4 may be coupled to loops 150, 151, 152, and 153 to allow for lifting of the bag.

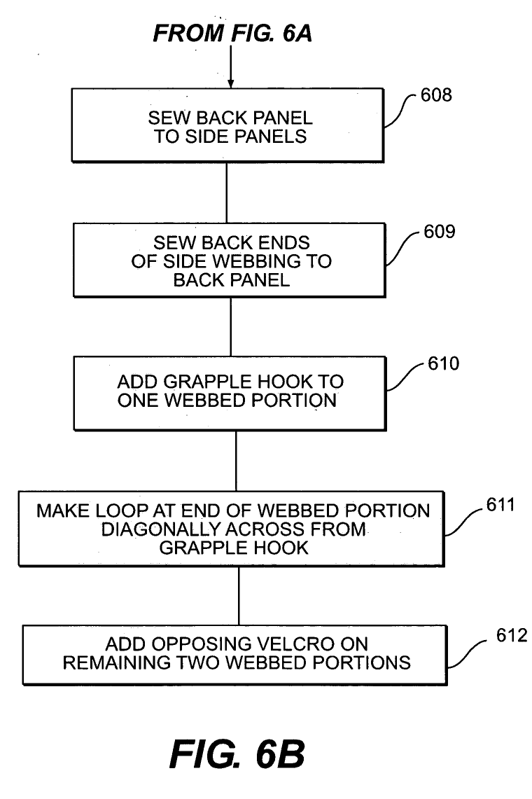

Schematic diagrams of a bag according to an embodiment of the present invention may be found in FIGS. 5A-F. FIGS. 5A-F are schematic diagrams, from varying viewpoints, of bag 501. Bag 501 is similar to bag 101 described above with respect to FIG. 1A, with similar components used for similar purposes. In general, as described herein, the “back” of the bag is the end portion of the bag that is closed during the bag filling operation; the “front” of the bag is the end portion of the bag that is open during the bag filling operation.

FIG. 5A shows a bottom view of bag 501. Bag 501 comprises a side panel 502 and a back panel 503. Webbed sections 504 and 505 (similar to webbed section 107) are also provided. Moreover, ropes 506-509 are also provided for coupling bag 501 to cams (not shown). Also attached to bag 501 is webbed section 510 which wraps around bag 501. Attached to webbed section 510 are loops 511 and 512. As discussed with respect to FIG. 1A, webbed sections 504 and 505 are only coupled to the side panels up to a certain point, here, point 513. The section of side panel 502 beyond point 513 forms flap 514, which can later be used to close bag 501.

FIG. 5B shows a back view of bag 501. Back panel 503 is shown, as well as ropes 508 and 509. Moreover, webbed sections 504, 505, 515 and 516 are shown forming diagonals across back panel 503. They are preferably sewn onto back panel 503 in the arrangement shown in order to assist in maintaining bag 501 in a closed position on the back end.

FIG. 5C shows a right side view of bag 501. In addition to the elements first shown and described with respect to previously described views, FIG. 5C contains loop 517, which is similar to loops 511 and 512, and is coupled to webbed section 510. Moreover, flap 518 is shown which is very similar to flap 514. Finally, uncoupled end portion 519 of webbed portion 516 is shown.

FIG. 5D shows a left side view of bag 501. In addition to the elements first shown and described with respect to previously described views, FIG. 5D contains loop 520 (similar to loop 517) and coupled to webbed section 510. Also shown are flap 521 and uncoupled end portion 522 which are similar to flap 518 and uncoupled end portion 519, respectively.

FIG. 5E is a top view of bag 501. In addition to the elements first shown and described with respect to previously described views, FIG. 5E contains loops 523 and 524 (similar to loop 517) and coupled to webbed section 510. Also shown is flap 525 which is similar to flap 518.

Finally, FIG. 5F is a front view of bag 501. In addition to the elements first shown and described with respect to previously described views, FIG. 5F contains uncoupled end portions 526 and 527 which are similar to uncoupled end portion 519.

Now will be described a method of assembling a bag according to an embodiment of the present invention. The bag whose assembly will now be described is similar in material and components to bag 101 described above.

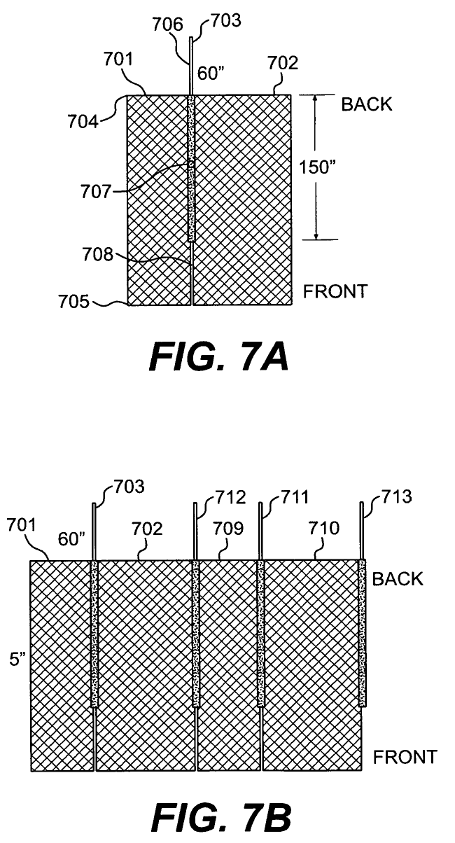

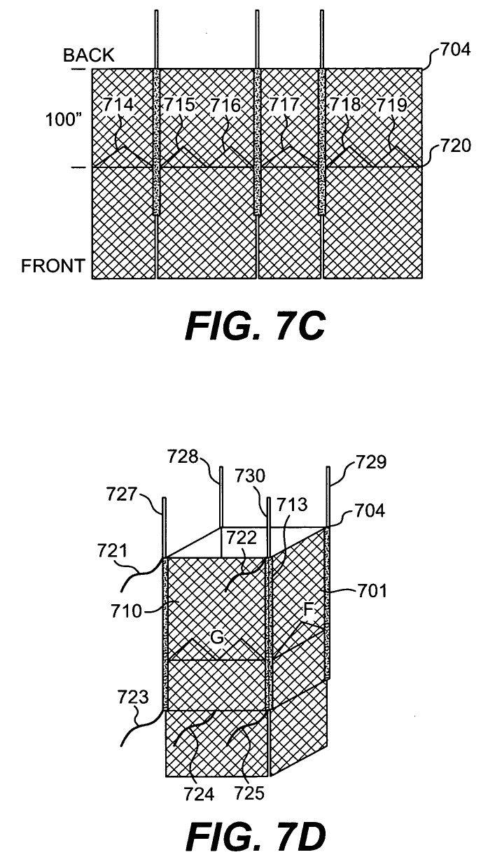

As shown in FIG. 6A, the first step, step 601, in the process is coupling two side panels together using a webbed section. Thus, as shown in FIG. 7A, side panels 701 and 702 are coupled using webbed section 703. In the embodiment shown in FIG. 7A, side panel 701 is 64 in. by 216 in., and side panel 702 is 100 in. by 216 in. Webbed section 703 is preferably 2 in wide and approximately 272 in. long. Preferably, there are essentially 3 portions of webbed section 703. The first portion, portion 706 extends approximately 60 in. beyond the back end 704 of the side panels. The second portion, portion 707, is sewn to side panels 701 and 702 over approximately the first 150 in. of these panels. (This leaves approximately 66 in. of the side panels unconnected.) The third portion, portion 708, is approximately 62 in. of the webbed section 703 that is unconnected to the side panel near the front end 705.

The second step in the process, step 602, is repeating step 601 using a second set of side panels and webbed section. The third step, step 603, is joining the section of the bag created by step 601 with the section of the bag created by step 602. The results of steps 602 and 603 can be seen in FIG. 7B. As shown in FIG. 7B, the section created by step 602 comprises side panels 709 and 710, which are connected by webbed portion 711. This section is connected to the section from step 601 using webbed portion 712, which is coupled to the side panels in a fashion similar to that which is described with respect to webbed portion 703. Also, as part of step 603, webbed portion 713 may be coupled to side panel 710, also in a fashion similar to webbed portion 703.

In the fourth step in the process, step 604, side webbing is added to the side panels approximately 100 in. from the back end of the side panels. Thus, as shown in FIG. 7C, side webbing 720 is added approximately 100 in. from back end 704 of the side panels.

In the fifth step in the process, step 605, a series of loops are added, and coupled to the side webbing added in the previous step. As can be seen in FIG. 7C, a total of six loops, 714-719, are added.

In the next step in the process, step 606, the unconnected ends of the side panels are connected so as to form a continuous bag. As can be seen in FIG. 7D, unconnected side panel 701 is connected to side panel 710 using webbed portion 713 to form a continuous bag.

In the next step in the process, step 607, nylon ropes are sewn to the bag, which will be used to secure the bag to a truck. As can be seen in FIG. 7D, five nylon ropes, 721-725 are added to the bag.

Referring now to FIG. 6B, in the next step in the process, step 608, the back panel of the bag is added by sewing it to the side panels. As can be seen in FIG. 7E, back panel 726 is coupled to the side panels to close off the back portion of the bag.

In the next step in the process, step 609, the portions of the webbed sections that extend beyond the back end 704 of the side panels are sewn to the back panel to provide further support to the back panel. Thus, as can be seen in FIG. 7D for example, a section of each side webbing extends beyond the back end 704 of the side panels. These sections (727-730) are folded over and sewn to the back panel 726 as shown in FIG. 7E.

In the next step in the process, step 610, a grapple hook is added to the end of one of the webbed portions near the front end 705 of the side panels. Thus, as shown in FIG. 7E, grapple hook 731 is attached to the end of webbed portion 713.

In the next step in the process, step 611, a loop is made on the end of the webbed portion diagonally across from the webbed portion with the grapple hook. Thus, on the front end of the webbed portion diagonally across from webbed portion 713 (FIG. 7E), a loop should be made that can hook into the grapple hook when the time comes to close the bag.

Finally, in the last step in the process, step 612, opposing Velcro is added to the remaining two webbed portions at the front end of those webbed portions. Thus, as shown in FIG. 7E, opposing Velcro is added at points 732 and 733 in order to further assist closing the bag when the time comes to move it.

The bag of the present of the present invention may be made in a wide variety of sizes. One preferred size would allow the bag to fit into a conventional chipper truck. Such a bag would have dimensions of approximately 12 feet long by 8 feet wide by 5 feet high. One of ordinary skill in the art would recognize, however, that these are merely representative dimensions and that the bag may be designed with various other dimensions depending on the application.

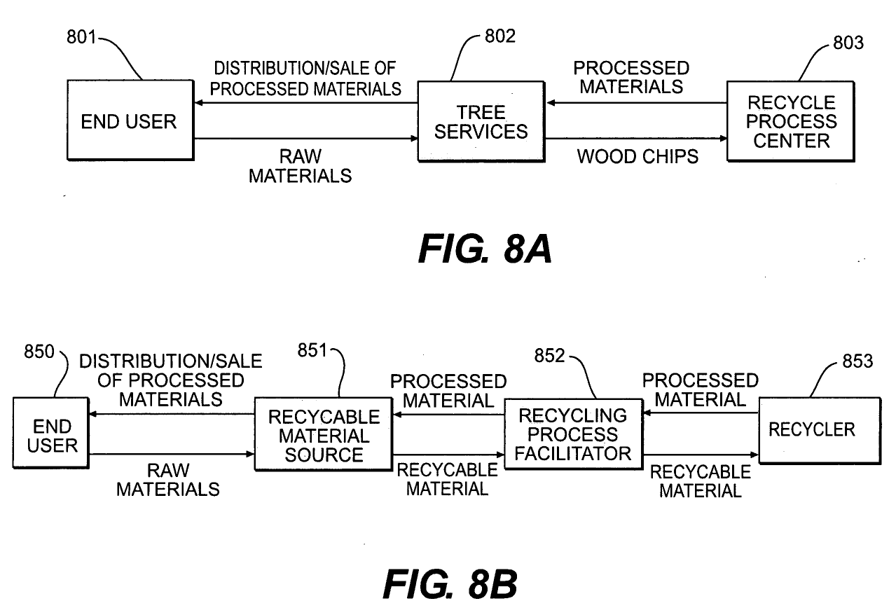

In addition to the embodiments described above, a bag according to an embodiment of the present invention may be used outside the context of a wood chip truck, or other similar truck. Thus, for example, a bag such as bag 101 described above with respect to FIG. 1A could be used with a frame designed to hold it open. The precise design of such a frame is not critical so long as it held the bag open to a reasonable degree such that wood chips or the like could be deposited within the bag. An example of such an embodiment is shown in FIG. 9. Thus, a bag such as bag 101 is contained in a frame 901, which serves to hold the bag in an open position so that is can be filled with material.

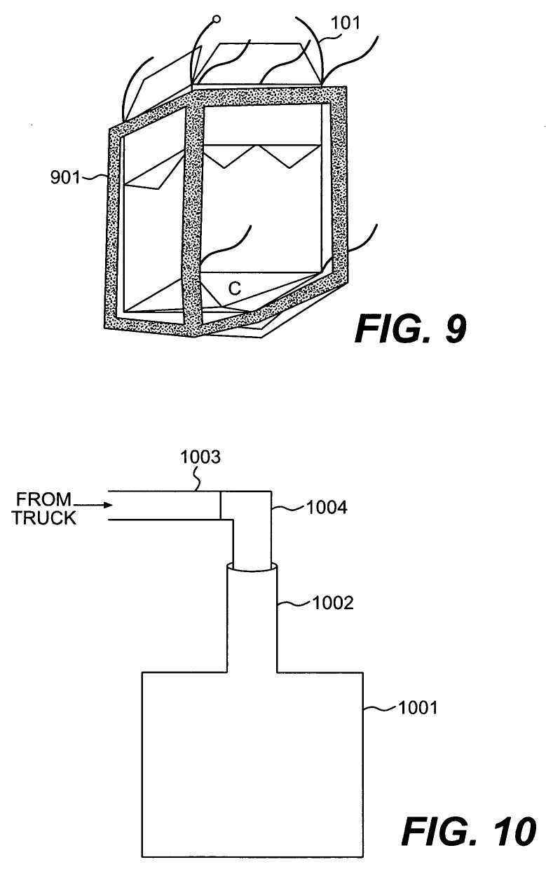

An alternative bag arrangement does not even need a frame in order to be held in place. Instead, as shown in FIG. 10, a bag, such as bag 1001, may be provided. Bag 1001 is similar in structure to the one described with respect to FIG. 1A. However, bag 1001 contains a chute 1002 into which wood chips or the like may deposited by a wood chip truck. In general, the chute 1002 may be connected to the chipper chute 1003 from the wood chip truck. This may require, for example, an attachment 1004 to the wood chip truck chute that directs the chips downward toward the ground and into the chute 1002, as shown in FIG. 10. The air from the wood chip truck serves to inflate the bag and allows it stand on the ground or other surface without need of a frame. Such an arrangement may be useful with any of the bag or designs disclosed herein. For example, the bag 1001 may contain closing or locking mechanisms described with respect to FIGS. 1A and 1B.

Also encompassed within the present invention is a novel and innovative business method for conducting a recycling business, which will be described below.

Recycling centers were created due to governmental mandates to reduce the amount of waste being disposed of in landfills. One important area for recycling is the recycling of wood and wood by-products. While the market for recycled wood and wood by-products is currently in its infancy, it continues to grow due to state and Federal regulations mandating the reduction of landfill use. At present, while there is no shortage of raw material being sent to wood recycling centers, distribution channels for serving the end-market for recycled products have not fully developed.

In general, the wood by-product recycling business derives its income from the intake of unprocessed wood by-products, such as wood chips, stumps and timber, and the sale and distribution of processed materials such as mulch, soil and compost. Tree services, which specialize in the removal of trees, often provide the raw materials for such recycling business but derive no income from the later sale of recycled products. However, often the end market consumer of such recycled products is the same as the customer of the tree service who was the ultimate source of the raw material. Thus, while tree services have a pre-existing relationship with the end customers, and provide the raw materials to the recycling centers, they do not participate in the end sale of recycled products.

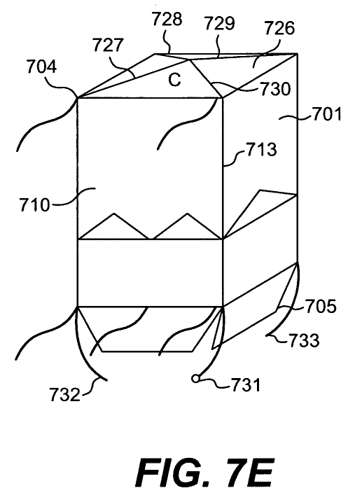

In an embodiment of the present invention, the wood recycling process is changed such that tree services participate not only in providing material to recycling centers, but also in distributing recycled products back to the end-user. Such a method is illustrated in FIG. 8A. In FIG. 8A, an end user 801 such as a residential or commercial entity, contracts with a tree service 802 to remove trees from a given job site. This results in raw materials being provided to the tree service 802. In performing the tree removal, tree service 802 generates recyclable material such as wood chips and the like which may be provided to a recycler, such as recycle process center 803. At the recycle process center 803, these wood chips and the like are processed and converted into re-usable items such as mulch. These processed materials are then provided back to tree service 802, which has the pre-existing relationship with the end-user 801, and tree service 802 can distribute or sell this material to the end-user 801.

One aspect of this embodiment of the invention is that the tree service 802 utilizes a bag, such as bag 101 in collecting wood chips and the like. Thus, as these bags are filled, they can be removed from the tree service's trucks and placed at a convenient location. These bags are then picked up by trucks sent by the recycle process center 803, where they can be loaded onto transportation trucks by grapple boom trucks.

Another embodiment of a recycling business method is described with respect to FIG. 8B. In FIG. 8B, an end user 850 contracts with a recyclable material source 851, such as a tree service, to remove raw material such as trees or the like from a property. Recyclable material source 851 processes the raw material into a recyclable material, such as wood chips. Recycling process facilitator 852 takes the recyclable material and delivers it to a recycler 853 such as a recycling process center. In a preferred embodiment, recycling process facilitator 852 provides bags, such as that described above with respect to FIG. 1A, to the recyclable material source 851 in order to assist in the collection of the recyclable material. Recycler 853 then processes the recyclable material, converting it into a processed material (e.g., mulch) and delivers it back to recycling process facilitator 852, who in turn delivers it to recyclable material source 851. This recyclable material source 851 can then distribute/sell the processed material back to end user 850.

In another embodiment, recycling process facilitator 852 and recycler 853 may be the same entity. Moreover, recycling process facilitator 852 may directly distribute the processed material back to the end user 850, rather than going through the recyclable material source 851:

Thus, in one embodiment of the present invention, unlike the conventional methods by which this business is conducted, the tree service or other recyclable material source is involved in the distribution chain of processed materials back to the end users. Thus, tree services or the like are paid dividends based on the volume of raw material obtained from end users or the amount of recyclable material provided to the recycling center.

The present invention may also be useful to collect saw dust from fire wood processors and to deliver that saw dust to end users, such as stables that use the saw dust as bedding.

The above-described preferred embodiments are intended to illustrate the principles of the invention, but not to limit its scope. Various other embodiments may occur to those skilled in the art upon reading the present disclosure or practicing the claimed invention. Such variations, modifications and equivalents are intended to come within the scope of the invention and the appended claims.

1. A method for collecting a processed material comprising:
providing a vehicle having a volume with an open end;
disposing a bag in the volume such that the bag lines substantially the entire volume and has an opening adjacent to the open end of the volume;
depositing a processed material into the bag; and
removing the bag with the deposited processed material from the volume.

2. An apparatus for collecting a processed material comprising:
a bag comprising a plurality of panels and a webbed portion;
wherein a first panel and a second panel are coupled by the webbed portion;
wherein the bag is configured to define an enclosed bag volume with an open bag end;
wherein the bag is configured to be utilized with a vehicle, wherein the vehicle has a vehicle volume with an open vehicle end, wherein the bag is configured to line substantially the entire vehicle volume, wherein the open bag end is adjacent to the open vehicle end; and
wherein the bag is further configured to collect the processed material.

3. An apparatus for collecting a processed material comprising:
a bag comprising a plurality of panels and a webbed portion, wherein a first panel and a second panel are coupled by the webbed portion and wherein the bag defines an enclosed volume with an open end; and
a frame, wherein the frame is configured to maintain the bag in a position such that the processed material can be disposed in the open end.

4. A method for conducting a recycling business comprising:
obtaining raw materials from an end user;
processing the raw material into a recyclable material;
delivering the recyclable material to a recycler to process into a processed material;
selling the processed material to the end user; and
receiving payment responsive to a volume of raw material obtained from the end user.

5. A method for conducting a recycling business comprising:
obtaining a recyclable material from a recyclable material source, wherein the recyclable material source obtained raw material from an end user and processed the raw material into the recyclable material;
delivering the recyclable material to a recycler to process into a processed material; and
delivering the processed material to the recyclable material source, wherein the recyclable material source sells the processed material to the end user, and wherein the recyclable material source receives payment responsive to a volume of raw material obtained from the end user.
